(19) United States
(12) Patent Application Publication
(10) Pub. No.: US 2015/0294810 A1
(43) Pub. Date: Oct. 15, 2015

(54) SWITCH

(71) Applicant: Wittenstein AG, Igersheim (DE)

(72) Inventors: Johannes Mark, Bad Mergentheim (DE); Markus Glaser, Huttlingen (DE); Christoph Hansli, Weikersheim (DE)

(21) Appl. No.: 14/686,112

(22) Filed: Apr. 14, 2015

(30) Foreign Application Priority Data
Apr. 14, 2014 (DE) 10 2014 105 305.2

(51) Int. Cl. H01H 3/60; H01H 3/40; H01H 3/30

(52) U.S. Cl. CPC H01H 3/60; H01H 3/30; H01H 3/40; H01H 2231/044; H01H 2221/062

(57) ABSTRACT

Switch (1), in particular a subsea switch, having a plurality of contact elements which are fixedly connected to one another, a plurality of connectors which are fixedly connected to one another, wherein each one of the connectors is adapted for receiving one of the contact elements, an actuator (10) which is adapted for moving the contact elements in a forcibly guided manner in relation to the connectors.

### BACKGROUND OF THE INVENTION

The invention relates to a switch, in particular to a subsea switch, and to a use of such a switch.

Switches comprising spring-loaded contacts for “subsea” use are known from the prior art. The contacts are closed counter to a spring force by means of an electric motor. When the motor is switched off, the spring pushes back the contact and the current flow is interrupted.

A relay or a contactor often has the disadvantage of a large size and of consuming much power. Furthermore, it is often the case that vibrations cannot be compensated for.

U.S. Pat. No. 3,848,949 discloses pins which may be brought into contact in a linear manner by means of threads.

It is disadvantageous in the prior art that in the case of some switches springs have to be provided in a compulsory manner in order for the contacts to be opened. Furthermore, in the case of known switches there are often no two secure states, since a restoring movement is performed by means of a spring. Further disadvantages may include a susceptibility of the contact to vibrations.

It is an object of the invention to provide an improved switched, in particular a subsea switch, for underwater use. In particular, disadvantages of the prior art are to be mitigated or eliminated; for example, secure contact or two secure states may be desirable.

### SUMMARY OF THE INVENTION

The object is achieved by a switch according to the present invention.

One aspect of the invention relates to a switch having a plurality of contact elements which are fixedly connected to one another, and a plurality of connectors which are fixedly connected to one another, wherein each one of the connectors is adapted for receiving one of the contact elements. The switch furthermore comprises an actuator which is adapted for moving the contact elements in a forcibly guided manner in relation to the connectors. In this way, closing an electrical connection between one of the contact elements and one of the connectors, respectively, is possible by activating the actuator. Here, one contact element interconnects to one connector, respectively. Furthermore, by way of the actuator a second position of the contact elements in relation to the connectors, in which no electrical connection between the contact elements on the one hand and the connectors on the other hand exists, may be reached.

A further aspect of the invention relates to a use of a switch in one of the typical embodiments described herein for switching an electrical circuit in a maritime depth of at least 10 meters or at least 30 meters.

Typical embodiments comprise at least 2 or at least 10 or at least 20 contact elements. This offers the advantage that numerous contacts may be closed in parallel. Typically, an identical number of connectors or, if applicable, counter-connectors are provided.

The actuator typically provides a linear movement of the contact element in relation to the connector, in particular in the direction of an axial direction of the connector, or an axial direction of a contact element which is implemented as a pin. Typically, the axial directions of the contact elements, of the connectors, and of the counter-connectors which are provided in some typical embodiments, are oriented so as to be parallel with one another. In kinematical terms, this facilitates simultaneous activation of the contact elements, connectors, or counter-connectors in order to open or close an electrical contact.

In typical embodiments of the invention the switch is implemented as a subsea switch. The switch is typically adapted so as to be employed in maritime depths of more than 10 meters or more than 30 meters. Typical embodiments comprise a housing with sealed lead throughs, for example for electrical power-supply cables or electrical control cables. Furthermore, sealed lead throughs for supply or dissipation cables to be connected or isolated may be provided. These supply or dissipation cables are typically connected to the contact elements, the connectors, or the counter-connectors.

In typical embodiments of the invention the contact element comprises a pin or a stud. Pins of embodiments may have a polygonal or a circular cross section, or a cross section having rounded corners. The connectors or counter-connectors typically are adapted to the cross section of the contact elements. In typical embodiments each of the contact elements comprises one pin, respectively, wherein the connectors or the counter-connectors are adapted so that in the case of the contact element being received in a connector or in a counter-connector, the at least a section of the pin is completely enclosed. Unless otherwise stated, receiving here is also understood to include partial receiving of the contact element, that is to say also partial receiving of a pin of the contact element, for example. Typically, the pin is at least in part completely enclosed. Here “enclosed” typically means that at least one portion of the pin is surrounded in all radial directions by the connector. Particularly in the case of vibrations such embodiments enable reliable contact. Typical embodiments comprise contact elements having in each case two pins, namely one pin for contacting the corresponding connector and one pin, which is axially opposed to the first pin, for contacting the counter-connector.

Typically, the contact elements, the connectors, or in some embodiments having counter-connectors, the counter-connectors are exclusively movable by the actuator, respectively. This offers the advantage of simple construction. Typical embodiments of switches of the invention are without a return spring. This may offer the advantage that unreliable restoring by means of return springs can be dispensed with.

In typical embodiments the actuator is an electromotive actuator. Typical electromotive actuators comprise at least one electric machine. In typical embodiments the actuator is implemented so as to be redundant. Typical actuators which are implemented so as to be redundant comprise at least one second electric machine, two sets of control electronics, or two gearboxes. This offers the advantage that in the case of a failure of, for example, one electric machine of the actuator a second electric machine of the actuator can ensure the functional capability of the actuator. For example two electric machines which drive a common spur wheel rotating an output drive, for example a spindle, are provided in some embodiments. The at least one electric machine may likewise be implemented having two redundant coils.

Further typical embodiments comprise hydraulically or pneumatically driven actuators. This may be meaningful in environments in which employment of one electric machine is unsuitable or has disadvantages. A further advantage may be that hydraulic or pneumatic systems which are available anyway may be availed of, such that costs for an electric drive may be saved in certain circumstances. Typically, the actuator is controllable in an electric manner, for example by way of a control line or via wireless remote control. This enables remote control, for example from a control room or from a ship. A control unit for actuating the actuator may also be provided within a housing of the switch in some embodiments. Typical embodiments of control units are adapted for transmitting a feedback signal pertaining to the state of the switch. Such feedback signals may comprise items of information pertaining to a functional capability, a switching state, or a temperature of the switch, for example.

Typical embodiments of switches of the invention comprise a spindle nut which is moved by a spindle. In typical embodiments the spindle is connected to an output drive shaft of the actuator. Typically, the spindle nut is disposed so as to be displaceable in a linear manner and fixedly connected to the contact elements, or in the case of other embodiments, fixedly connected to the connectors and, if applicable, to the counter-connectors. In this way, forced guiding of the contact elements and of the connectors in relation to one another is achieved. In further embodiments the contact elements, connectors, or counter-connectors, are moved in relation to one another by a rack-and-pinion assembly. The pinion may be connected to the output drive shaft of the actuator, for example. Typical embodiments comprise cam disks, eccentrics, connecting rods, or toggle levers for translating a rotating movement of the actuator into an axial movement of the contact elements, of the connectors, or of the counter-connectors.

Switch according to one of the preceding claims, having a plurality of counter-connectors which are fixedly connected to one another, wherein each one of the counter-connectors is adapted for receiving in one of the contact elements, and in each case one counter-connector in a moving direction of the contact element lies opposite one connector, respectively. This offers the advantage that the connectors or the counter-connectors may be selectively contacted by the contact elements. The counter-connectors and the connectors in some embodiments of the invention are disposed so as to be spaced apart, so as to enable an intermediate position of the contact elements between the connectors and the counter-connectors. In this manner it may be achieved that the contact elements can be isolated from any contact with the connectors or the counter-connectors.

In typical embodiments the counter-connectors are fixedly connected to the connectors. In this way construction can be simplified. In further exemplary embodiments the counter-connectors are disposed so as to be movable in relation to the connectors. In this way electric circuits having a comparatively large number of possibilities can be switched.

Typically, at least part of the connectors, or at least part of the counter-connectors, in each case comprise an electrically conducting spring element, wherein, in the case of a contact element being received in the respective connector, the spring element is adapted for contacting and tensioning the respective contact element. In the case of contact elements which comprise a pin, the spring element is disposed such that the respective pin is contacted by the respective spring element. In further embodiments the contact elements are implemented in an optical or fluidic manner.

Typical embodiments may have the following advantages. Forcibly guided states which can be accurately determined exist. Typical switches, in particular in the case of embodiments having at least a partially enclosed contact element, are comparatively robust with respect to vibrations.

In this way an enforced static state can be established. Typical embodiments have high reliability, since few moving components are provided and no spring as an actuator element is compulsory. Typical switches of the invention have a high power density, since a plurality of contacts can be simultaneously activated. There is typically high flexibility; the contacts may therefore be used as signal contacts or high current contacts. All contact elements and connectors are in each case implemented in an identical manner in some embodiments; in further embodiments contact elements of variable size which may be employed for various purposes are provided. Electricity is not necessarily required for maintaining the position in some embodiments.

### BRIEF DESCRIPTION OF THE DRAWINGS

Further advantages and features of preferred embodiments of the invention are explained in the following by means of the appended drawings, wherein:

FIG. 1 shows an in-principle diagram of a typical embodiment of a switch according to the invention; and

FIG. 2 shows a schematic sectional plan view of an embodiment of a switch according to the invention;

FIG. 3 shows a redundant power supply of an actuator of exemplary embodiments of the invention; and

FIG. 4 shows an in-principle diagram of how pins are received in a connector of some embodiments.

### DETAILED DESCRIPTION

Typical embodiments will be described in the following by means of the figures, the invention not being limited to the exemplary embodiments, but the scope of the invention rather being defined by the claims.

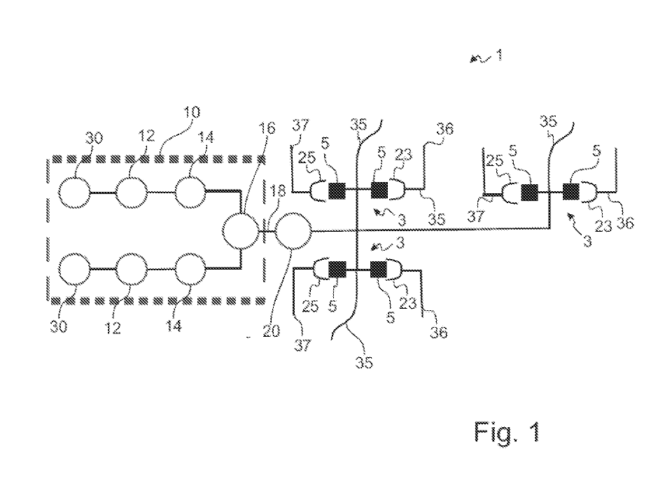

FIG. 1 is an in-principle diagram of a typical embodiment of a switch 1 according to the invention. The switch 1 comprises three contact elements 3 which in each case dispose of two pins 5. Driving the contact elements is performed by means of an actuator 10 which comprises two electric machines 12. The electric machines 12, via reduction-gear units 14, drive a summation gear 16 which, via a spindle 18, drives a spindle nut 20. The spindle nut 20 which is mounted so as to be rotationally fixed and axially displaceable, in the exemplary embodiment of FIG. 1 by means of a linear guide, sits on the spindle 18. The contact elements 3 are fastened on the spindle nut 20 by way of the pins 5. The contact elements 3 can be moved in relation to connectors 23 and counter-connectors 25 by rotating the spindle 18. By way of engagement of in each case one pin 5 in one connector 23, an electrical connection between the pin 5 and the connector 23 is established. By way of engagement of the pin 5 in the connector 23, an axial portion of the pin 5 is radially encompassed by the connector 23, the pin 5 thus being partially enclosed by the connector 23. In an analogous manner this applies to a movement of the contact element 3 in the opposite direction, wherein the pin 5 lying in each case opposite the contact element is partially enclosed by the respective counter-connector 25. The pins 5 in the connector 23 and in the counter-connector 25 are contacted by electrically conducting spring elements, respectively, which tension the respective pins 5 and keep them in position (see FIG. 4).

The electric machines 12 are connected to assigned control units 30, respectively. In this way, there is redundancy also in the case of the control units. The control units 30 can be remote controlled by way of a control line. The contact elements 3 are in each case connected to cables 35, the connectors 23 are in each case connected to cables 36, and the counter-connectors 25 are in each case connected to cables 37. The cables 35, 36, and 37 in typical embodiments are routed to a water-impermeable lead through. In this way, elements which are outside a housing of the switch 1 can be switched.

In the variant of embodiment shown in FIG. 1, the spindle nut is movable between two end positions, wherein at least one contact, typically in each case at least one connector or one counter-connector, is disposed at the respective end position. By way of movement of the spindle nut between the end positions in each case one contact may be closed while another contact is simultaneously opened. Thus switching between two electric circuits in a system which is of redundant design is possible. Furthermore, typical embodiments enable positioning of the contact element between the respective connectors and counter-connectors, such that complete isolation of a power supply, for example, is possible. In further embodiments no counter-connectors are provided, such that contacting of the connectors is only possible by way of the contact elements. This leads to simplified construction.

On account of the employment of the switch in extreme conditions, in particular in regions of employment which are difficult to reach, the drive in some variants of embodiment, such as the embodiment of FIG. 1, for example, is implemented so as to be redundant.

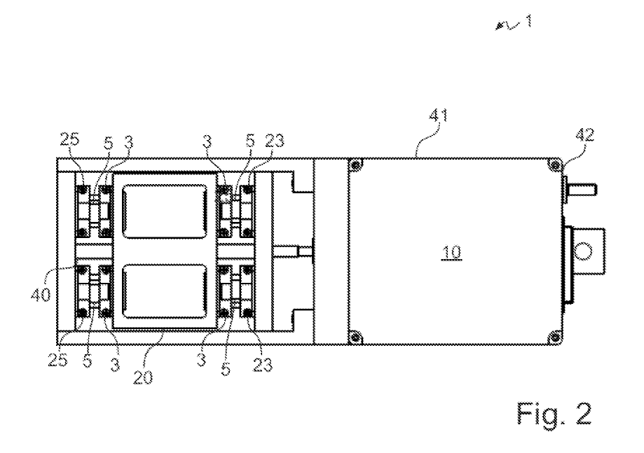

A sectional plan view of an embodiment of a switch according to the invention is shown in FIG. 2. The embodiment of FIG. 2 in terms of its constructive principle substantially corresponds to the principle shown in the in-principle diagram of FIG. 1. Identical or similar parts are identified using the same reference signs as in FIG. 1 and may not be described again.

The embodiment of FIG. 2 relates to a switch 1 which is employable as a subsea switch. The switch 1 comprises an actuator 10 which is constructed so as to be redundant (see FIG. 1) and which can move a spindle nut 20 which is mounted so as to be displaceable in a linear manner on a linear guide 40 by way of a spindle 18. Thereby contact elements 3 which are fixedly connected to the spindle nut 20 are displaced in a linear manner in the axial direction of the spindle 18. Each of the contact elements 3 comprises two pins 5, respectively, which are disposed in the axial direction on both sides of the contact element. Depending on the position of the spindle nut, in each case a section of the pins 5 may be received in connectors 23 or in counter-connectors 25, or be disposed in an intermediate position between the connectors 23 and the counter-connectors 25.

In further exemplary embodiments the connectors, and if provided, the counter-connectors are fixedly connected to one another and to a spindle nut. In such exemplary embodiments the contact elements typically are fixedly disposed in relation to the housing, such that the connectors and, if applicable, the counter-connectors are moved in relation to the housing and to the contact elements.

Like further typical embodiments, the switch of FIG. 2 comprises a water-tight housing 41. A cable lead through 42 by way of which control lines and power supply lines as well as cables (in FIG. 1: reference signs 35, 36, and 37) of the connectors 23, of the counter-connectors 25, and of the contact elements 3 are guided, is disposed in the housing 41. In this way, operation of the switch is also possible under water and in adverse environmental conditions.

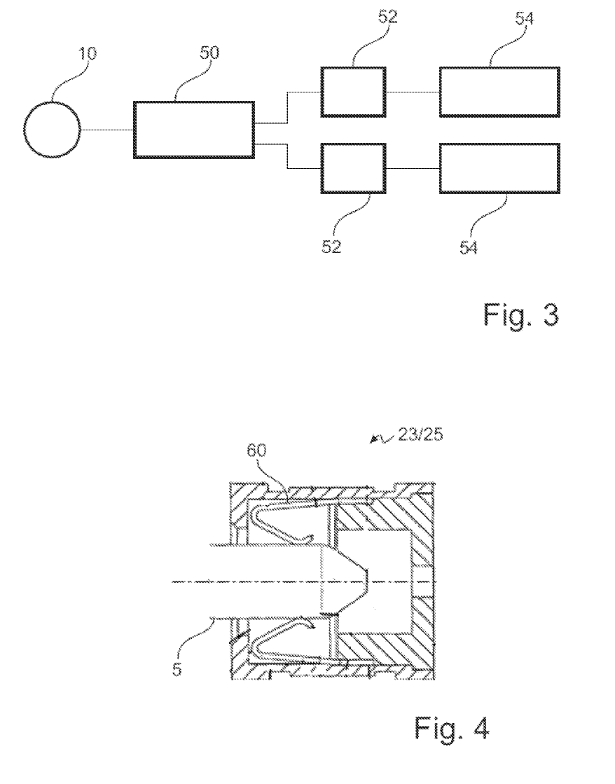

A redundant power supply of an actuator 10 of exemplary embodiments of the invention is shown in FIG. 3. The actuator, via a supply switch 50, is connected to two redundant monitoring units 52 which dispose of dedicated power sources 54, respectively. The monitoring units 52 determine whether switching takes place and, if applicable, at what point in time. To this end, the monitoring units 52 are connected to the control units 30. Furthermore, the monitoring units determine a nominal position, monitor and control and deliver feedback to a system which is, if applicable, superordinate. The control units 30 comprise the control and regulating electronics for the electric machines 12 of the actuators 10.

In a further exemplary embodiment the switch has three contact positions. Apart from the two end positions described in the context of the previous exemplary embodiment, the switch may assume a third position which is disposed between the two end positions. In this third position, which can also be referred to as an intermediate position, the switch, by way of a forcibly guided plug-connector element or a cam switch, closes a further contact. This further contact of the third contact position is typically closed so as to be orthogonal to the movement direction of the spindle nut or to a guide carriage which is connected to the spindle nut.

In FIG. 4 an in-principle diagram shows how in the connector 23, or in the counter-connector 25, the pins 5 are in each case contacted by electrically conducting spring elements 60 which tension the respective pins 5 and keep them in position.

1. A switch, comprising
a plurality of contact elements which are fixedly connected to one another;
a plurality of connectors which are fixedly connected to one another, wherein each one of the connectors is adapted for receiving in one of the contact elements; and
an actuator which is adapted for moving the contact elements in a forcibly guided manner in relation to the connectors.

2. The switch according to claim 1, wherein either the contact elements or the connectors are exclusively movable by the actuator, respectively.

3. The switch according to claim 1, wherein the actuator is an electromotive actuator.

4. The switch according to claim 1, wherein the switch is without a return spring.

5. The switch according to claim 1, further comprising a plurality of counter-connectors which are fixedly connected to one another, wherein each of the counter connectors is adapted for receiving one of the contact elements, and in each case one counter-connector in a moving direction of the contact element lies opposite one connector.

6. The switch according to claim 5, wherein the counter-connectors are fixedly connected to the connectors.

7. The switch according to claim 1, wherein at least part of the connectors and/or of the counter-connectors in each case comprise an electrically conducting spring element, wherein, in the case of a contact element being received in the respective connector, the spring element is adapted for contacting and tensioning the respective contact element.

8. The switch according to claim 1, wherein each of the contact elements comprise one pin, wherein the connectors and/or the counter-connectors are adapted so that in the case of the pin of the contact element being received in a connector or in a counter connector, at least a section of the pin is completely enclosed.

9. The switch according to claim 1, wherein the actuator is implemented so as to be redundant.

10. (canceled)
